(19) United States
(12) Patent Application Publication
(10) Pub. No.: US 2024/0024986 A1
(43) Pub. Date: Jan. 25, 2024

(54) SYSTEMS FOR LASER WELDING WITH PLASMA PROTECTION

(71) Applicant: GM GLOBAL TECHNOLOGY OPERATIONS LLC, Detroit, MI (US)

(72) Inventors: Baixuan Yang, Canton, MI (US); Wei Zeng, Oakland Township, MI (US); Hui-ping Wang, Troy, MI (US); Stephen Kyle Greutman, Sterling Heights, MI (US); Eric Barnhart, Clinton Township, MI (US); Andrew Hromadka, Ann Arbor, MI (US)

(73) Assignee: GM GLOBAL TECHNOLOGY OPERATIONS LLC, Detroit, MI (US)

(21) Appl. No.: 17/814,637

(22) Filed: Jul. 25, 2022

(51) Int. Cl. B23K 26/70; B23K 26/244; B23K 26/22; B23K 37/04; B23K 26/142

(52) U.S. Cl. CPC B23K 26/706; B23K 26/244; B23K 26/22; B23K 37/04; B23K 26/142

(57) ABSTRACT

A laser welding system for joining a first workpiece to a second workpiece includes a laser welder configured to emit a laser beam at a power to form a weld to join the first workpiece and the second workpiece at a weld location. The laser welding system includes a plasma protection fixture coupled to a surface of at least the first workpiece. The plasma protection fixture defines an opening configured to receive the laser beam. The opening has a perimeter that surrounds and is spaced apart from the weld. The plasma protection fixture has a height above the surface of at least the first workpiece about the perimeter of the opening that is defined based on the power of the laser beam.

### INTRODUCTION

The technical field generally relates to laser welding, and more particularly relates to systems for laser welding with plasma protection to ensure proper weld penetration depth.

In laser welding, a high density light source is employed to melt the material of the parts to be joined. The parts to be joined are placed substantially in contact with each other, and a laser beam is directed by the laser welding machine to shine on the parts to fuse the parts together. At the point where the laser beam intersects the parts, a pool of melted material is formed that comingles the material of the parts being joined. In certain instances, both melted material and metal vapor may be formed during laser welding. The metal vapor may displace a region of melted material in the melt pool, for example, at the point the laser beam enters the parts to form a keyhole. In addition, metal vapor may condense into small particles in the form of a plume during the welding process. The plume may interfere with the laser beam, and the small particles may also agglomerate into larger sized particles, which may also attenuate the laser beam. Generally, it is desirable to remove the plume to ensure that the laser beam is not affected. Hot weld plasma may be formed above the keyhole, however, which helps to preserve the thermal energy of the keyhole. The removal of the weld plasma above the keyhole may result in reduced stability of the keyhole opening, reduced weld penetration depth or inconsistency in the weld formed.

Accordingly, it is desirable to provide systems for laser welding with plasma protection, which enables the removal of the plume while providing improved weld penetration depth and weld consistency. Furthermore, other desirable features and characteristics of the present invention will become apparent from the subsequent detailed description and the appended claims, taken in conjunction with the accompanying drawings and the foregoing technical field and background.

### SUMMARY

According to various embodiments, provided is a laser welding system for joining a first workpiece to a second workpiece. The laser welding system includes a laser welder configured to emit a laser beam at a power to form a weld to join the first workpiece and the second workpiece at a weld location. The laser welding system includes a plasma protection fixture coupled to a surface of at least the first workpiece. The plasma protection fixture defines an opening configured to receive the laser beam. The opening has a perimeter that surrounds and is spaced apart from the weld. The plasma protection fixture has a height above the surface of at least the first workpiece about the perimeter of the opening that is defined based on the power of the laser beam.

The height is 3 millimeters to 5 millimeters, and the power of the laser beam is greater than 3 kilowatts. The height is 5 millimeters to 10 millimeters, and the power of the laser beam is less than 3 kilowatts. The laser welding system includes a secondary gas system configured to direct a flow of a gas over the surface of at least the first workpiece and the height of the plasma protection fixture is configured to inhibit the flow of the gas from disturbing weld plasma at the weld location. The plasma protection fixture defines a plurality of the opening, which are spaced apart on the plasma protection fixture from a first fixture side to a second fixture side. The weld location is a first surface of the first workpiece. The first workpiece is joined to the second workpiece with an overlap joint. The opening is rectangular, and the weld is a linear stitch weld formed along a weld path. The linear stitch weld is centered in the opening, and the secondary gas system is configured to direct the flow of the gas in a direction parallel to the weld path such that the flow of the gas follows the weld path. The weld location is a first surface of the first workpiece, and the first workpiece is joined to the second workpiece with an overlap joint. The opening is rectangular. The weld is at least one spot weld, and the at least one spot weld is positioned within the opening. The plasma protection fixture includes a coupling system configured to apply a pressure to at least the first workpiece. The plasma protection fixture defines a fixture bore, and the coupling system comprises a mechanical fastener configured to be received through the fixture bore to apply the pressure to at least the first workpiece. The mechanical fastener is a turn screw or a spring pin. The laser welder is operable in a keyhole welding mode and a conduction welding mode, and the height above the surface of at least the first workpiece about the perimeter of the opening is defined based on the keyhole welding mode or the conduction welding mode. The weld location is the surface of the first workpiece proximate a first end of the first workpiece and a second surface of the second workpiece proximate a second end of the second workpiece, and the first workpiece is joined to the second workpiece with a butt joint. The weld location is a first surface of the first workpiece, and the first workpiece is joined to the second workpiece with an overlap joint. The plasma protection fixture includes at least one handle.

Further provided is a laser welding system for joining a first workpiece to a second workpiece. The laser welding system includes a laser welder configured to emit a laser beam at a power to form a weld to join the first workpiece and the second workpiece along a weld path. The laser welder is operable in a welding mode, and the welding mode includes a keyhole welding mode and a conduction welding mode. The laser welding system includes a secondary gas system configured to direct a flow of a gas over a surface of at least the first workpiece in a direction parallel to the weld path such that the flow of the gas follows the weld path. The laser welding system includes a plasma protection fixture defining a fixture bore and a coupling system including a mechanical fastener configured to be received through the fixture bore and configured to apply a pressure to the surface of at least the first workpiece. The plasma protection fixture defines an opening configured to receive the laser beam, and the coupling system is defined about a perimeter of the opening. The perimeter of the opening surrounds and is spaced apart from the weld path that is defined within the opening. The plasma protection fixture has a height above the surface of at least the first workpiece about the perimeter of the opening that is defined based on the welding mode and the height of the plasma protection fixture is configured to inhibit the flow of the gas from disturbing weld plasma along the weld path.

The height is 3 millimeters to 5 millimeters, and the welding mode is the keyhole welding mode. The height is 5 millimeters to 10 millimeters and the welding mode is the conduction welding mode. The plasma protection fixture defines a plurality of the opening, which are spaced apart on the plasma protection fixture from a first fixture side to a second fixture side. The opening is rectangular, and the weld path is linear to form a stitch weld. The mechanical fastener is a turn screw, a spring pin, or a spring biased pin.

### BRIEF DESCRIPTION OF THE DRAWINGS

The exemplary embodiments will hereinafter be described in conjunction with the following drawing figures, wherein like numerals denote like elements, and wherein:

FIG. 1 is a schematic partially cross-sectional illustration of a laser welding system that includes an exemplary plasma protection fixture for plasma protection in accordance with various embodiments, with the plasma protection fixture, a first workpiece and a second workpiece shown in cross-section taken along line 1-1 of FIG. 3;

FIG. 2 is a schematic partially cross-sectional illustration of the laser welding system of FIG. 1, taken along line 2-2 of FIG. 3, with a laser welding machine of the laser welding system removed for clarity;

FIG. 3 is a schematic perspective view of the plasma protection fixture, the first workpiece and the second workpiece of FIG. 1, with the laser welding machine of the laser welding system removed for clarity;

FIG. 4 is a schematic perspective view of another exemplary plasma protection fixture, a first workpiece and a second workpiece for laser welding with the laser welding machine of FIG. 1, in which the laser welding machine is removed for clarity;

FIG. 5 is a schematic perspective view of another exemplary plasma protection fixture, a first workpiece and a second workpiece for laser welding with the laser welding machine of FIG. 1, in which the laser welding machine is removed for clarity; and

FIG. 6 is a schematic perspective view of the plasma protection fixture being used at an exemplary weld location defined between a first workpiece and a second workpiece for laser welding with the laser welding machine of FIG. 1, in which the laser welding machine is removed for clarity.

### DETAILED DESCRIPTION

The following detailed description is merely exemplary in nature and is not intended to limit the application and uses. Furthermore, there is no intention to be bound by any expressed or implied theory presented in the preceding introduction, brief summary or the following detailed description. In addition, those skilled in the art will appreciate that embodiments of the present disclosure may be practiced in conjunction with any number of systems, and that the systems described herein are merely exemplary embodiments of the present disclosure.

For the sake of brevity, conventional techniques related to signal processing, data transmission, signaling, control, machine learning models, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure. As used herein, the term “substantially” denotes within 10% to account for manufacturing tolerances and the term “about” denotes within 10% to account for manufacturing tolerances.

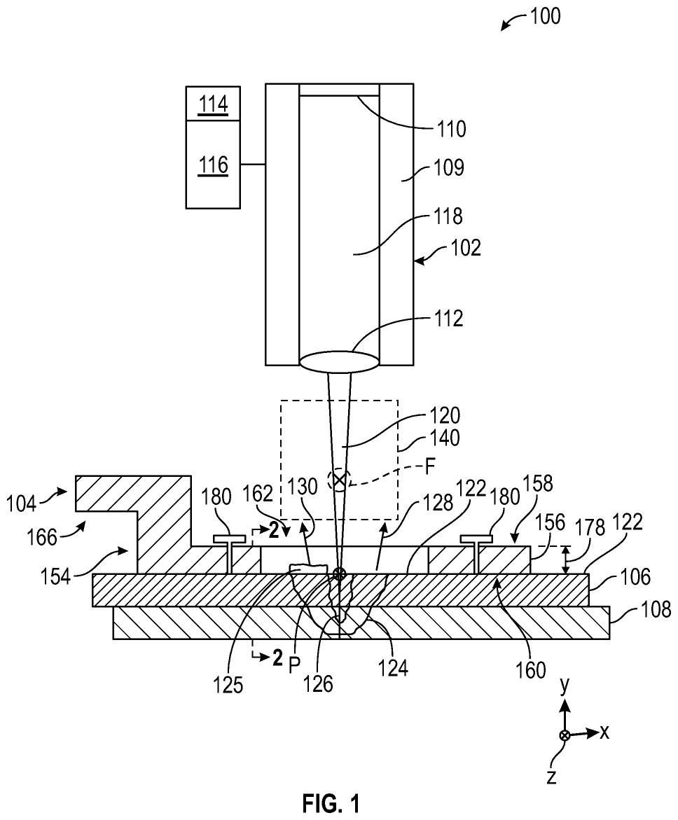

With reference to FIG. 1, a laser welding system 100 is shown. In one example, the laser welding system 100 includes a laser welder or laser welding machine 102, a plasma protection fixture 104, a first workpiece 106 and a second workpiece 108. It should be noted that while the plasma protection fixture 104 is described herein as being used with a laser welding system 100, the plasma protection fixture 104 may be used with any suitable welding system. In one example, the laser welding machine 102 includes a light source 109, a reflector 110, optics 112, a power supply 114 and a controller 116. The controller 116 includes a processor and a memory that stores executable instructions for the operation of the laser welding machine 102. The light source 109 is powered and controlled by the power supply 114 and the controller 116 to generate light into a resonant cavity 118. The light is expanded and reflected by the reflector 110 through the optics 112 to emerge as a concentrated laser beam 120 focused to a point at the first workpiece 106. The laser welding machine 102 is configured to apply the laser beam 120 at a weld location to form a weld to join the first workpiece 106 to the second workpiece 108. Generally, the laser welding machine 102 may be controlled by the controller 116 to produce a predetermined type of weld at the weld location, including, but not limited to, a spot weld, a stitch weld, or a staple weld. In the example of a stitch weld shown in FIG. 1, the laser welding machine 102 is controlled to move the beam across the first workpiece 106 along a predetermined linear weld path P, which is protected by the plasma protection fixture 104. The laser welding machine 102 is also controlled by the controller 116 to operate in a keyhole welding mode or a conduction welding mode. Generally, in the conduction welding mode, the power of the laser beam 120 is low or less than the power of the laser beam 120 in the keyhole welding mode so that a keyhole is not formed in the conduction welding mode. In the example of the first workpiece 106 and the second workpiece 108 composed of steel, in the keyhole welding mode, the laser beam 120 output by the laser welding machine 102 has a power of greater than 3 kilowatts (kw). In the example of the first workpiece 106 and the second workpiece 108 composed of steel, in the conduction welding mode, the laser beam 120 output by the laser welding machine 102 has a power of less than 3 kilowatts (kw). Thus, the laser welding machine 102 outputs the laser beam 120 at a first power (greater than 3 kilowatts (kw)) in the keyhole welding mode or at a second power (less than 3 kilowatts (kw)) in the conduction welding mode. In this example, the laser welding machine 102 has a laser power density that is greater than 100,000 Watts per centimeters squared (W/cm²). It should be noted that the illustration of the laser welding machine 102 in FIG. 1 is merely exemplary as the light source 109 may be configured as stand-alone equipment standing on the floor, with fiber optics delivering the laser beam 120 from the light source 109 to the optics 112 for laser welding.

In one example, the keyhole welding mode is employed to form the weld to join the first workpiece 106 and the second workpiece 108 along the straight line defined by the weld path P. The laser beam 120 is directed at the first workpiece 106. Generally, the optics 112 are spaced apart from a surface 122 of the first workpiece 106 such that the laser beam 120 passes through an air space defined between the optics 112 and the first workpiece 106. The first workpiece 106 and the second workpiece 108 are joined by the laser welding machine 102 along the weld path P. The laser beam 120 is directed along the weld path P, which creates a keyhole 126 and a melt pool 124. In this example, as the laser beam 120 traverses along the linear weld path P, the keyhole 126 and the melt pool 124 develops. The laser beam 120 may travel along the linear weld path P with or without oscillations in transverse and inline direction. The surface 122 of the first workpiece 106 being directly hit by the laser beam 120 heats up and may evaporate. As the metal vapor leaves the surface 122, it generates recoil pressure which pushes a free surface of the melt pool 124 downward to form a deep and narrow cavity referred to as the keyhole 126 that penetrates the molten material and is full of the weld plasma 125, which is ionized metal vapor. The weld plasma 125 also exists above the keyhole 126 and in an area surrounding the keyhole 126. The existence of hot weld plasma 125 above the keyhole 126 helps to preserve the heat in the area of the keyhole 126, which is beneficial to the stability of the laser welding process. Above the surface 122, metal vapor and particles flow out of the melt pool 124 and the keyhole 126 forming a plume 130, which is above the area of the weld plasma 125 and further away from the hot melt pool 124 and the keyhole 126. The plume 130 is colder than the weld plasma 125, and the plume 130 has particles of at least or greater than 80 nanometers (nm) that may interfere with the laser beam 120 reaching the first workpiece 106. The particles in the plume 130 may also attenuate, scatter, or dampen the laser beam 120. As a result, the laser energy reaching the surface 122 may be reduced and may fluctuate, and it may not be possible to maintain the keyhole 126 in a stable state, which increases spatter, process instability and may lead to reduced weld penetration depth. In addition to damping the laser beam 120 by the plume 130, spatter contained in the plume 130 may contaminate or damage the optics 112 of the laser welding machine 102, which is undesirable.

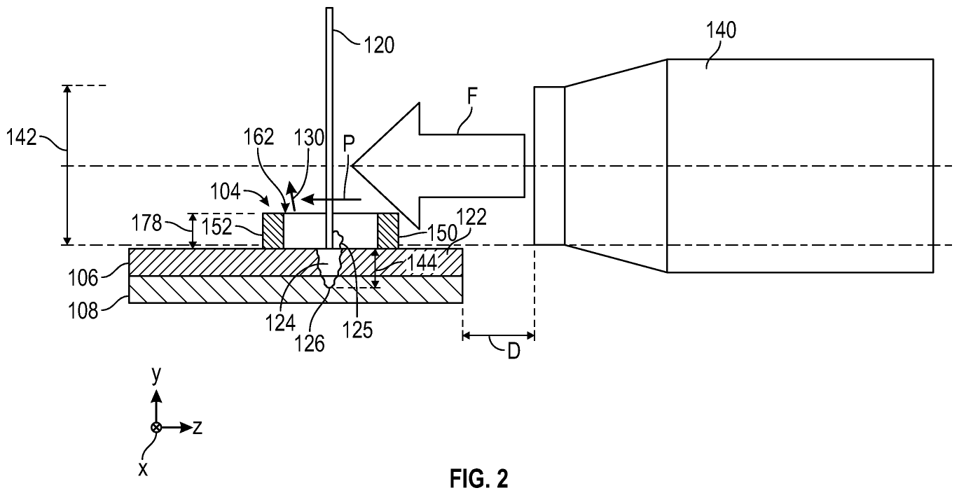

In one example, the laser welding system 100 includes a secondary gas system 140 (FIG. 2). The secondary gas system 140 directs a laminar flow of gas F, such as air or another inert gas, in the direction parallel to the surface 122 of the first workpiece 106. In one example, the flow of the gas F is parallel to a movement of the laser beam 120 along the weld path P. Stated another way, the secondary gas system 140 directs the laminar flow of gas F in a direction that is substantially parallel to the weld path P such that the flow of the gas F follows or flows against the weld path P. In the example of FIG. 1, the weld path P is linear, and extends into the page, and thus, the secondary gas system 140 directs the gas F into the page when the gas F follows the weld path P or out of the page in the example of the gas F flowing against the weld path P.

With reference to FIG. 2, in this example, the secondary gas system 140 is a blower or a fan, which outputs the flow of the gas F at about 5 meters per second (m/s) to about 20 meters per second (m/s) in a direction parallel to the surface 122 of the first workpiece 106. The secondary gas system 140 directs the substantially laminar flow of the gas F along the direction of the weld path P. Generally, the flow of the gas F is output by the secondary gas system 140 such that the gas F spans a gas height 142 above the surface 122 of the first workpiece 106 in a vertical or Y-direction. In one example, the gas height 142 is about 90 millimeters (mm) to about 110 millimeters (mm). Generally, the gas height 142 is predetermined to enable the flow of the gas F to blow the plume 130 generated during the laser welding of the workpieces 106, 108 away from the path of the laser beam 120 coming toward the surface 122. By directing the flow of the gas F toward the laser beam 120 in the direction of the weld path P and along the gas height 142, the obstruction of the laser beam 120 by the weld plume 130 is greatly reduced during the laser welding of the workpieces 106, 108. As a result, the reduced interruption of the laser beam 120 by the plume 130 leads to consistent laser energy coming toward the surface 122 and the weld formed by the laser beam 120 is more consistent. In one example, the secondary gas system 140 is spaced a predetermined distance D away from the first workpiece 106, however, generally, the secondary gas system 140 may be positioned at any location that enables the secondary gas system 140 to provide the gas F at the predetermined velocity that follows or flows against the weld path P.

As the secondary gas system 140 directs the gas F along surface 122 of the first workpiece 106 at the gas height 142, without the plasma protection fixture 104, the gas F would disturb or displace the hot weld plasma 125 along the surface 122, which may affect a weld penetration depth 144. In this regard, a weld penetration depth 144 is defined by a depth of the keyhole 126. The hot weld plasma 125 assists in maintaining the heat in the area surrounding the keyhole 126, which enables the formation of a deeper keyhole 126. Disturbing or displacing the hot weld plasma 125 from the area surrounding the keyhole 126 reduces the temperature of the melt pool 124, which results in a shallower keyhole 126. The shallow keyhole 126, in turn, results in less weld penetration depth and may result in instability of the keyhole 126. Thus, the plasma protection fixture 104 surrounds the weld path P to protect the weld plasma 125 from the secondary gas system 140.

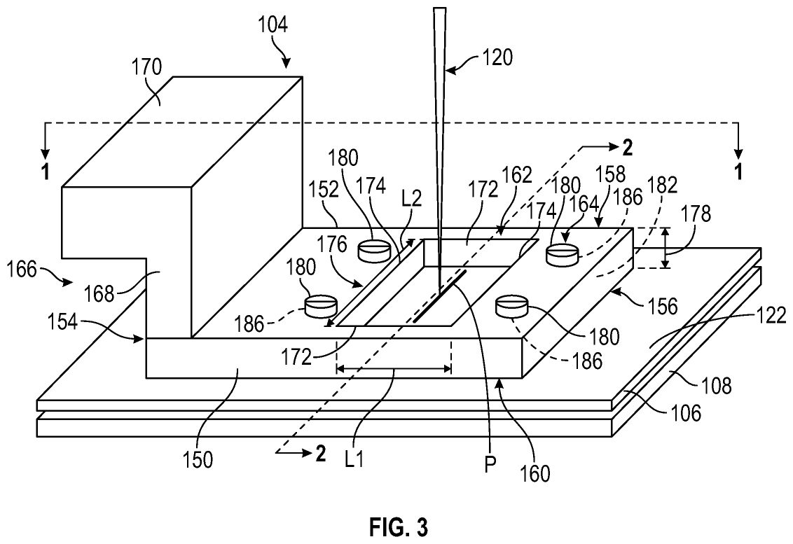

In one example, with reference to FIG. 3, a perspective view of the plasma protection fixture 104 coupled to the surface 122 of the first workpiece 106 is shown. The plasma protection fixture 104 is composed of metal or metal alloy, and may be cast, forged, stamped, additively manufactured, etc. In one example, the plasma protection fixture 104 is substantially rectangular, and includes a first fixture end 150 opposite a second fixture end 152, a first fixture side 154 opposite a second fixture side 156, and a first fixture surface 158 opposite a second fixture surface 160. The plasma protection fixture 104 also defines at least one opening 162 and at least one optional coupling system 164. The first fixture end 150 and the second fixture end 152 are each substantially smooth and planar. In one example, the first fixture side 154 includes a graspable portion or a handle 166. In this example, the handle 166 extends upwardly and outwardly in a substantially L-shape from the first fixture side 154. The handle 166 includes a base portion 168 that extends outwardly from the first fixture side 154, and a grip portion 170 that extends outwardly away from the base portion 168. The handle 166 may be integrally formed with the plasma protection fixture 104 or may be coupled to the first fixture side 154 via welding, mechanical fasteners, etc. The base portion 168 of the handle 166 extends from the first fixture end 150 to the second fixture end 152 along the first fixture surface 158 at the first fixture side 154, and the grip portion 170 enables a user to grasp the plasma protection fixture 104 to position the plasma protection fixture 104 on the surface 122 of the first workpiece 106. It should be noted that the L-shape of the handle 166 is merely exemplary. In addition, it should be noted that the plasma protection fixture 104 need not include the handle 166, if desired. Further, the second fixture side 156 may also include a handle, which extends upwardly and outwardly so as to be opposite the handle 166 of the first fixture side 154. The second fixture side 156 is substantially smooth and planar. The first fixture surface 158 is positioned proximate the laser welding machine 102 (FIG. 1), and the second fixture surface 160 is positioned on the surface 122 of the first workpiece 106 when the plasma protection fixture 104 is coupled to the first workpiece 106 to form an overlap joint.

In this example, the plasma protection fixture 104 defines a single opening 162. The opening 162 is defined through the plasma protection fixture 104 from the first fixture surface 158 to the second fixture surface 160. In this example, the opening 162 is defined so as to be offset between the first fixture side 154 and the second fixture side 156, or the opening 162 is defined so as to be proximate the second fixture side 156. It should be noted that the opening 162 may be defined through the first fixture surface 158 and the second fixture surface 160 at any predetermined location on the plasma protection fixture 104. In this example, the opening 162 is rectangular, and has a pair of opposite first sides 172 and a pair of opposite second sides 174. The first sides 172 and the second sides 174 may be coupled together with rounded or chamfered corners, or may be coupled together with square or 90 degree corners. The first sides 172 have a first length L1, which is different and less than a second length L2 of each of the second sides 174. Generally, the length L1, L2 of the sides 172, 174 is predetermined based on the dimension of the weld and includes a safety envelope on either side of the weld path P. Thus, the first length L1 and the second length L2 are each predetermined to provide a safety envelope on either side of the weld path P. For example, the first length L1 is about 5 millimeters (mm) to about 20 millimeters (mm), and the second length L2 is about 10 millimeters (mm) to about 30 millimeters (mm). The first sides 172 are defined parallel to the first fixture end 150 and the second fixture end 152, and the second sides 174 are defined parallel to the first fixture side 154 and the second fixture side 156. The first sides 172 and the second sides 174 cooperate to define a perimeter 176 of the opening 162. The perimeter 176 surrounds the weld location, which in this example, is the surface 122 of the first workpiece 106 to form an overlap joint between the first workpiece 106 and the second workpiece 108. The perimeter 176 of the opening 162 is spaced apart from the weld path P to provide the safety envelope. The perimeter 176 of the opening 162 may also act as a guide for the placement of the weld, as the user may center the weld on the weld path P within the perimeter 176 defined by the sides 172, 174. Thus, generally, the opening 162 of the plasma protection fixture 104 defines the weld path P for the weld, which is centered within the opening 162. It should be noted that although not illustrated herein, the sides 172 may include markings to assist the user in centering the weld along the weld path P defined by the opening 162.

The perimeter 176 of the opening 162 also has a height 178, which in this example, is the same along or about the perimeter 176. Stated another way, the first sides 172 and the second sides 174 each have the height 178. The height 178 is measured from the first fixture surface 158 to the second fixture surface 160, or is the height 178 of the plasma protection fixture 104 above the surface 122 of the first workpiece 106. In this example, the height 178 is defined based on the power of the laser beam 120. If the power of the laser beam 120 is greater than 3 kilowatts (kw), the height 178 of the perimeter 176 of the opening 162 is about 3 millimeters (mm) to about 5 millimeters (mm). If the laser beam 120 output by the laser welding machine 102 has a power of less than 3 kilowatts (kw), the height 178 of the perimeter 176 of the opening 162 is about 5 millimeters (mm) to about 10 millimeters (mm). Stated another way, the height 178 is defined based on the welding mode of the laser welding machine 102. If the laser welding machine 102 is in the keyhole welding mode, the height 178 of the perimeter 176 of the opening 162 is about 3 millimeters (mm) to about 5 millimeters (mm). If the laser welding machine 102 is in the conduction welding mode, the height 178 of the perimeter 176 of the opening 162 is about 5 millimeters (mm) to about 10 millimeters (mm). Thus, the height 178 of the plasma protection fixture 104 above the surface 122 of the first workpiece 106 is based on the power of the laser beam 120 or based on the welding mode of the laser welding machine 102. The height 178 of the opening 162 of the plasma protection fixture 104 inhibits the weld plasma 125 (FIG. 2) from being disturbed by the flow of the gas F from the secondary gas system 140, which ensures weld consistency and the weld penetration depth 144.

In this regard, if the height 178 of the perimeter 176 of the opening 162 is less than about 3 millimeters (mm) in the keyhole welding mode or less than about 5 millimeters (mm) in the conduction welding mode, the flow of the gas F from the secondary gas system 140 will push the weld plasma 125 away from the area surrounding the keyhole 126, which results in an unstable keyhole 126 and reduced weld penetration depth. If the height 178 of the perimeter 176 of the opening 162 is greater than about 5 millimeters (mm) in the keyhole welding mode or greater than about 10 millimeters (mm) in the conduction welding mode, the flow of the gas F from the secondary gas system 140 will be obstructed by the plasma protection fixture 104 and there will not be enough gas flow proximate the surface 122 to blow the plume 130 away from in front of the weld plasma 125, resulting in the attenuation of the laser beam 120 by the plume 130 and weld inconsistency. In this example, the laser welding machine 102 (FIG. 1) is in the keyhole welding mode, and the height 178 of the perimeter 176 of the opening 162 of the plasma protection fixture 104 is about 3 millimeters (mm) to about 5 millimeters (mm).

The coupling system 164 assists in closing any gap that may exist between the first workpiece 106 and the second workpiece 108. It should be noted that the coupling system 164 may be optional. In one example, the coupling system 164 includes a plurality of mechanical fasteners 180, which are each the same. The plasma protection fixture 104 also includes a plurality of fixture bores 186. In this example, the fixture bores 186 are defined through the plasma protection fixture 104 from the first fixture surface 158 to the second fixture surface 160. The fixture bores 186 are defined so as to be positioned adjacent to, next to or near corners of the perimeter 176. Thus, generally, the coupling system 164 is defined about the perimeter 176 of the opening 162. In this example, the plasma protection fixture 104 defines four fixture bores 186 that receive a respective one of four mechanical fasteners 180, however, the plasma protection fixture 104 may include any number of fixture bores 186 and mechanical fasteners 180, including, but not limited to, a single fixture bore 186 and a single mechanical fastener 180 associated with the opening 162.

In this example, each of the mechanical fasteners 180 is a screw, which includes a plurality of threads. Once the plasma protection fixture 104 is positioned on the surface 122 of the first workpiece 106, the mechanical fasteners 180 are turned to close any gaps defined between the first workpiece 106 and the second workpiece 108 (FIG. 1). Stated another way, the coupling system 164 applies a pressure to the first workpiece 106 to push the first workpiece 106 against the second workpiece 108 to ensure there is contact between the first workpiece 106 and the second workpiece 108 during forming of the overlap joint. Thus, the coupling system 164 assists in eliminating gaps existing between the first workpiece 106 and the second workpiece 108. The coupling system 164 also ensures the proper positioning between the first workpiece 106 and the second workpiece 108, and also inhibits or prevents thermal distortion. Alternatively, each of the mechanical fasteners 180 may comprise spring pins, which are positioned through the respective fixture bores 186 to apply pressure to the first workpiece 106 to close any gaps between the first workpiece 106 and the second workpiece 108. As a further alternative, each of the mechanical fasteners 180 may comprise spring biased pins, which are positioned through the respective fixture bores 186 to apply pressure to the first workpiece 106 to close any gaps between the first workpiece 106 and the second workpiece 108. Generally, the coupling system 164 closes any gap present between the first workpiece 106 and the second workpiece 108. By closing the gap, a quality of the weld is improved as possible open areas between the first workpiece 106 and the second workpiece 108 are substantially eliminated.

Generally, the first workpiece 106 and the second workpiece 108 are each composed of metal or metal alloy. The first workpiece 106 and the second workpiece 108 may be composed of the same metal or metal alloy, or may be composed of different metals or metal alloys. The first workpiece 106 and the second workpiece 108 are illustrated herein as flat panels. It should be noted, however, that the first workpiece 106 may comprise a component with any desired shape, such as rectangular, square, etc., so long as the surface 122 of the first workpiece 106 is substantially planar for coupling to the plasma protection fixture 104. The second workpiece 108 may also comprise any desired shape, and thus, the first workpiece 106 and the second workpiece 108 illustrated herein are merely examples. Generally, the first workpiece 106 and the second workpiece 108 are automotive components, however, the first workpiece 106 and the second workpiece may comprise other components.

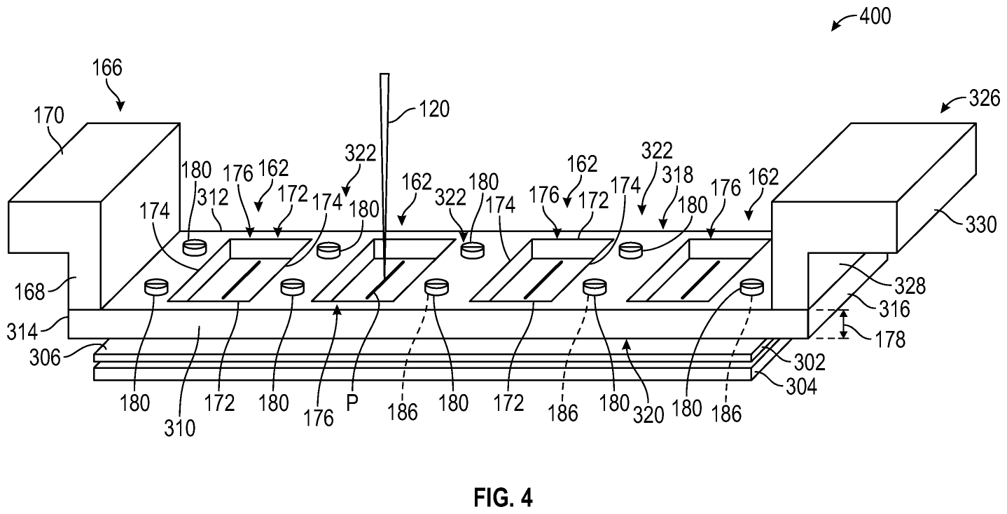

It should be noted that the plasma protection fixture 104 may be configured in various ways depending upon the type of weld to be formed between the first workpiece 106 and the second workpiece 108. For example, with reference to FIG. 4, a plasma protection fixture 300 is shown. As the plasma protection fixture 300 is similar to the plasma protection fixture 104 of FIGS. 1-3, the same reference numerals will be used to denote the same or substantially the same components. The plasma protection fixture 300 is used to laser weld a first workpiece 302 to a second workpiece 304 with the laser welding machine 102 (FIG. 1) to form an overlap joint between the first workpiece 302 and the second workpiece 304. In this example, the plasma protection fixture 300 is used to weld the first workpiece 302 to the second workpiece 304 via a plurality of stitch welds.

The plasma protection fixture 300 is coupled to a surface 306 of the first workpiece 302. The plasma protection fixture 300 is composed of metal or metal alloy, and may be cast, forged, stamped, additively manufactured, etc. In one example, the plasma protection fixture 300 is substantially rectangular and includes a first fixture end 310 opposite a second fixture end 312, a first fixture side 314 opposite a second fixture side 316, and a first fixture surface 318 opposite a second fixture surface 320. The plasma protection fixture 300 also defines at least one of the openings 162 and at least one optional coupling system 322. The first fixture end 310 and the second fixture end 312 are each substantially smooth and planar. In one example, the first fixture side 314 includes the handle 166. In this example, the second fixture side 316 also includes a handle 326 opposite the handle 166. The handle 326 extends upwardly and outwardly in a substantially L-shape from the second fixture side 316. The handle 326 includes a base portion 328 that extends upward from the second fixture side 316, and a grip portion 330 that extends outward from the base portion 328. The handle 326 may be integrally formed with the plasma protection fixture 300 or may be coupled to the second fixture side 316 via welding, mechanical fasteners, etc. The base portion 328 of the handle 326 extends from the first fixture end 310 to the second fixture end 312 along the first fixture surface 318 at the second fixture side 316, and the grip portion 330 enables a user to grasp the plasma protection fixture 300 to position the plasma protection fixture 300 on the surface 306 of the first workpiece 302. It should be noted that the L-shape of the handle 326 is merely exemplary. In addition, it should be noted that the plasma protection fixture 300 need not include the handles 166, 326, if desired. The first fixture surface 318 is positioned proximate the laser welding machine 102 (FIG. 1), and the second fixture surface 320 is positioned on the surface 306 of the first workpiece 302 when the plasma protection fixture 300 is coupled to the first workpiece 302.

In this example, the plasma protection fixture 300 defines a plurality of the openings 162, with one of the openings 162 associated with a respective one of the welds. Each of the openings 162 is defined through the plasma protection fixture 300 from the first fixture surface 318 to the second fixture surface 320. In this example, the openings 162 are defined so as to be spaced apart between the first fixture side 314 and the second fixture side 316. It should be noted that the openings 162 may be defined through the first fixture surface 318 and the second fixture surface 320 at any predetermined location on the plasma protection fixture 300 to position a weld for the workpieces 302, 304. Thus, it should be noted that while the openings 162 are about evenly spaced apart along the plasma protection fixture 300, the openings 162 may be unevenly spaced, arranged in clusters, or otherwise grouped as predetermined to form the appropriate welds between the workpieces 302, 304. The first sides 172 are defined parallel to the first fixture end 310 and the second fixture end 312, and the second sides 174 are defined parallel to the first fixture side 314 and the second fixture side 316. The perimeter 176 surrounds the weld location, which in this example, is the surface 306 of the first workpiece 302 to form an overlap joint between the first workpiece 302 and the second workpiece 304. The perimeter 176 of each of the openings 162 is spaced apart from the weld path P to provide the safety envelope. The perimeter 176 of each of the openings 162 may also act as a guide for the placement of the weld, as the user may center the weld on the weld path P within the perimeter 176 defined by the respective opening 162.

The perimeter 176 of each of the openings 162 also has the height 178, which in this example, is the same along the perimeter 176. Stated another way, the first sides 172 and the second sides 174 each have the height 178. The height 178 is measured from the first fixture surface 318 to the second fixture surface 320, or is the height 178 of the plasma protection fixture 300 above the surface 306 of the first workpiece 302. As discussed, the height 178 is defined based on the power of the laser beam 120 or the welding mode of the laser welding machine 102. Thus, the height 178 of the plasma protection fixture 300 above the surface 306 of the first workpiece 302 is based on the power of the laser beam 120 or the welding mode of the laser welding machine 102. The height 178 of the openings 162 of the plasma protection fixture 300 inhibits the weld plasma 125 (FIG. 2) from being disturbed by the flow of the gas F from the secondary gas system 140. In this example, the laser welding machine 102 (FIG. 1) is in the keyhole welding mode, and the height 178 of the perimeter 176 of each of the openings 162 of the plasma protection fixture 300 is about 3 millimeters (mm) to about 5 millimeters (mm).

The coupling system 322 assists in closing any gaps that may exist between the first workpiece 302 and the second workpiece 304. It should be noted that the coupling system 322 may be optional. In one example, the coupling system 322 includes the plurality of mechanical fasteners 180. The plasma protection fixture 300 also includes the plurality of fixture bores 186. In this example, the fixture bores 186 are defined through the plasma protection fixture 300 from the first fixture surface 318 to the second fixture surface 320. The fixture bores 186 are defined so as to be positioned adjacent to, next to or near corners of the perimeter 176 of each of the openings 162. In this example, the plasma protection fixture 300 defines ten fixture bores 186 that receive a respective one of ten mechanical fasteners 180, however, the plasma protection fixture 300 may include any number of fixture bores 186 and mechanical fasteners 180 including, but not limited to, a single fixture bore 186 and a single mechanical fastener 180 associated with each of the openings 162. Generally, the fixture bores 186 are defined on the plasma protection fixture 300 to be located at the respective four corners of each of the openings 162, and in this example, due to the positioning of the openings 162 certain mechanical fasteners 180 may be associated with multiple openings 162.

Once the plasma protection fixture 300 is coupled to or positioned on the surface 306 of the first workpiece 302, the mechanical fasteners 180 are coaxially aligned with the fixture bores 186, and turned to apply pressure to the first workpiece 302 to close any gaps between the first workpiece 302 and the second workpiece 304. Alternatively, each of the mechanical fasteners 180 may comprise spring pins, which are positioned through the respective fixture bores 186 to apply pressure to the first workpiece 302 to close any gaps between the first workpiece 302 and the second workpiece 304. As a further alternative, each of the mechanical fasteners 180 may comprise spring biased pins, which are positioned through the respective fixture bores 186 to apply pressure to the first workpiece 302 to close any gaps between the first workpiece 302 and the second workpiece 304. The coupling system 322 ensures that any gap present between the first workpiece 302 and the second workpiece 304 is substantially eliminated or closed. By closing the gap, a quality of the weld is improved as possible open areas between the first workpiece 302 and the second workpiece 304 are substantially eliminated.

The first workpiece 302 and the second workpiece 304 are each composed of metal or metal alloy. The first workpiece 302 and the second workpiece 304 may be composed of the same metal or metal alloy, or may be composed of different metals or metal alloys. The first workpiece 302 and the second workpiece 304 are illustrated herein as elongated flat panels. It should be noted, however, that the first workpiece 302 may comprise a component with any desired shape, such as rectangular, square, etc., so long as the surface 306 of the first workpiece 302 is substantially planar for coupling to the plasma protection fixture 300. The second workpiece 304 may also comprise any desired shape, and thus, the first workpiece 302 and the second workpiece 304 illustrated herein are merely examples. Generally, the first workpiece 302 and the second workpiece 304 are automotive components, however, the first workpiece 302 and the second workpiece 304 comprise other components.

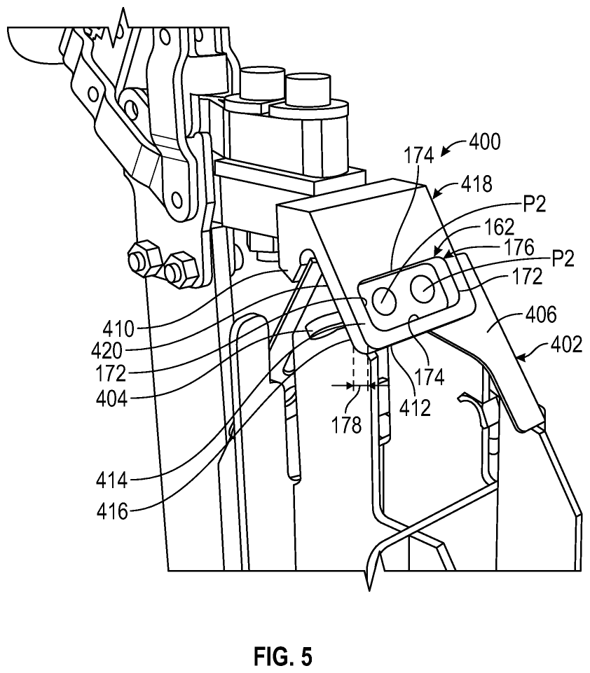

In addition, while the opening 162 of the plasma protection fixture 104 and the openings 162 of the plasma protection fixture 300 are illustrated herein as being configured to receive a single weld along the weld path P, in other embodiments, an opening of a plasma protection fixture may receive more than one weld and the plasma protection fixture may be shaped to correspond to the workpieces to be joined. For example, with reference to FIG. 5, a plasma protection fixture 400 is shown. As the plasma protection fixture 400 is similar to the plasma protection fixture 104 of FIGS. 1-3, the same reference numerals will be used to denote the same or substantially the same components. The plasma protection fixture 400 is used to laser weld a first workpiece 402 to a second workpiece 404 with the laser welding machine 102 (FIG. 1) to form an overlap joint between the first workpiece 402 and the second workpiece 404. In this example, the plasma protection fixture 400 is used to weld the first workpiece 402 to the second workpiece 404 via a plurality of spot welds.

The plasma protection fixture 400 is coupled to a surface 406 of the first workpiece 402. The plasma protection fixture 400 is composed of metal or metal alloy, and may be cast, forged, stamped, additively manufactured, etc. In one example, the plasma protection fixture 400 is substantially V-shaped, and includes a first fixture end 410 opposite a second fixture end 412, a first fixture side 414 opposite a second fixture side 416, and a first fixture surface 418 opposite a second fixture surface 420. The plasma protection fixture 400 also defines one of the openings 162. In this example, the plasma protection fixture 400 does not include a coupling system, however, the plasma protection fixture 400 may include a coupling system, such as the coupling system 164 discussed with regard to FIGS. 1-3.

The plasma protection fixture 400 may extend to the first fixture end 410 for a distance that is different and less than a distance the plasma protection fixture 400 extends to the second fixture end 412 such that the first fixture end 410 is offset from or uneven with the second fixture end 412. The plasma protection fixture 400 may have somewhat of an L-shape. The first fixture end 410 may define a groove 422 along the second fixture surface 420 to assist in coupling the plasma protection fixture 400 about the workpieces 402, 404. The second fixture end 412 is substantially smooth and planar. The first fixture side 414 and the second fixture side 416 are each substantially smooth and planar at the second fixture end 412. The first fixture surface 418 at the second fixture end 412 is positioned proximate the laser welding machine 102 (FIG. 1), and the second fixture surface 420 at the second fixture end 412 is positioned on the surface 406 of the first workpiece 402 when the plasma protection fixture 400 is coupled to the first workpiece 402.

In this example, the plasma protection fixture 400 defines the opening 162, and in this example, the opening 162 receives two welds. The opening 162 is defined through the plasma protection fixture 400 from the first fixture surface 418 to the second fixture surface 420. In this example, the opening 162 is defined so as to be proximate the second fixture end 412. It should be noted that the openings 162 may be defined through the first fixture surface 418 and the second fixture surface 420 at any predetermined location on the plasma protection fixture 400 to position a weld for the workpieces 402, 404. The first sides 172 are defined parallel to the first fixture side 414 and the second fixture side 416, and the second sides 174 are defined parallel to the second fixture end 412. The perimeter 176 surrounds the weld location, which in this example, is the surface 406 of the first workpiece 402 to form the overlap joint between the first workpiece 402 and the second workpiece 404. The weld formed at the weld location in this example comprises two spot welds, which are formed at two weld points P2 to couple the first workpiece 402 to the second workpiece 404. The perimeter 176 is spaced apart from the weld points P2 to provide the safety envelope. The perimeter 176 of the opening 162 may also act as a guide for the placement of the welds, as the user may center the weld points P2 within the perimeter 176 defined by the opening 162. It should be noted that alternatively, a single stitch weld may be formed in the opening 162 of the plasma protection fixture 400 at the weld location.

The perimeter 176 of the opening 162 also has the height 178, which in this example, is the same along the perimeter 176. Stated another way, the first sides 172 and the second sides 174 each have the height 178. The height 178 is measured from the first fixture surface 318 to the second fixture surface 320, or is the height 178 of the plasma protection fixture 400 above the surface 406 of the first workpiece 402. As discussed, the height 178 is defined based on the power of the laser beam 120, and the height 178 of the plasma protection fixture 400 above the surface 406 of the first workpiece 402 is based on the power of the laser beam 120. The height 178 of the openings 162 of the plasma protection fixture 400 inhibits the weld plasma 125 (FIG. 2) from being disturbed by the flow of the gas F from the secondary gas system 140. In this example, the laser welding machine 102 (FIG. 1) is in the conduction welding mode, and the height 178 of the perimeter 176 of the opening 162 of the plasma protection fixture 400 is about 5 millimeters (mm) to about 10 millimeters (mm).

The first workpiece 402 and the second workpiece 404 are each composed of metal or metal alloy. The first workpiece 402 and the second workpiece 404 may be composed of the same metal or metal alloy, or may be composed of different metals or metal alloys. In this example, the first workpiece 402 is an elongated shaped panel, and the second workpiece 404 is a mounting bracket. Generally, the first workpiece 402 and the second workpiece 404 are automotive components, however, the first workpiece 402 and the second workpiece 404 comprise other components.

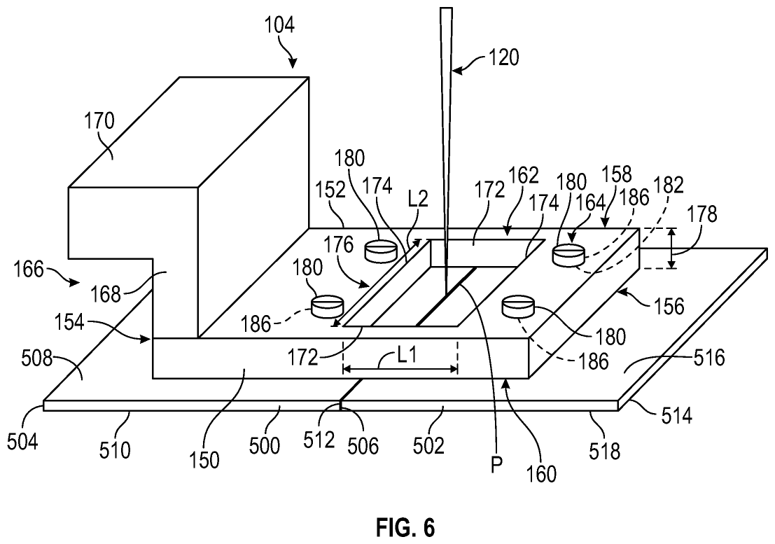

It should be noted that the plasma protection fixture 104 may be used to form welds at weld locations other than the surface 122 of the first workpiece 302. For example, with reference to FIG. 6, the plasma protection fixture 104 is shown employed with a first workpiece 500 and a second workpiece 502. In this example, the plasma protection fixture 104 is used to laser weld the first workpiece 500 to the second workpiece 502 to form a butt joint with the laser welding machine 102 (FIG. 1) via a stitch weld. In the example of FIG. 6, the first workpiece 500 includes a first workpiece end 504 opposite a second workpiece end 506, and a first workpiece surface 508 opposite a second workpiece surface 510. The first workpiece surface 508 and the second workpiece surface 510 each extend from the first workpiece end 504 to the second workpiece end 506. The second workpiece 502 includes a third workpiece end 512 opposite a fourth workpiece end 514, and a third workpiece surface 516 opposite a fourth workpiece surface 518. The third workpiece surface 516 and the fourth workpiece surface 518 each extend from the third workpiece end 512 to the fourth workpiece end 514.

In this example, the second workpiece end 506 abuts or is directly adjacent to the third workpiece end 512 to form the butt joint to join the first workpiece 500 to the second workpiece 502. Thus, the weld location in the example of FIG. 6 is the first workpiece surface 508 of the second workpiece end 506 and the third workpiece surface 516 of the third workpiece end 512. The plasma protection fixture 104 is positioned on the first workpiece surface 508 of the first workpiece 500 proximate the second workpiece end 506 and the third workpiece surface 516 of the second workpiece 502 proximate the third workpiece end 512. The opening 162 of the plasma protection fixture 104 is centered between the second workpiece end 506 and the third workpiece end 512 so that the weld path P is defined along the adjacent ends 506, 512. The weld path P is linear to form a stitch weld at the weld location. In this example, the coupling system 164 may be used to apply pressure to prevent thermal distortion between the first workpiece 500 and the second workpiece 502 during the laser welding process.

Thus, the plasma protection fixture 104, 300, 400 protects the weld plasma 125 (FIG. 2) on the surface 122, 306, 406 of the first workpiece 106, 302, 402 from the secondary gas system 140 (FIGS. 1 and 2), thereby resulting in improved weld penetration depth 144 (FIG. 2). Stated another way, the height 178 of the plasma protection fixture 104, 300, 400, which is predefined based on the power of the laser beam 120 or the welding mode of the laser welding machine 102, ensures that the weld plasma 125 (FIG. 1) remains on the melt pool 124, which ensures the consistent formation of the weld along the entirety of the keyhole 126. By providing the plasma protection fixture 104, 300, 400 along with the secondary gas system 140, the plume 130 does not interfere with the laser beam 120 and the gas F does not interfere with the weld plasma 125, resulting in consistent weld formation and consistent weld penetration depth 144. By protecting the weld plasma 125, the melt pool 124 remains hot and enables the formation of a deeper keyhole 126, which increases the weld penetration depth 144. By removing the plume 130 with the secondary gas system 140, the particles within the plume 130 do not interfere with the laser beam 120, ensuring consistency of the laser beam 120 along the weld path P. It should be noted that the spacing and orientation of the opening(s) 162, 662 on the respective plasma protection fixture 104, 300, 400 may be any predetermined spacing and orientation that ensures the weld between the respective workpieces 106, 108, 302, 304, 402, 404 meets predetermined requirements for strength, for example. Moreover, the size of the opening 162 may be predetermined based on the size of the weld. Further, the plasma protection fixture may have a shape that conforms to the workpieces to be joined while maintaining the height 178 about the perimeter 176 of the opening 162.

It should be noted that although the weld path P is shown in FIGS. 1-4 as linear, the weld path P may have other shapes to fit within the opening 162. For example, the laser welding machine 102 output the laser beam 120 to form a weld with a staple shape, a C-shape, a circular shape, etc. In addition, the laser welding machine 102 may output the laser beam 120 with the laser beam 120 moving along the weld path P with or without oscillations. It should also be noted that while the plasma protection fixture 104, 300 is described herein as being used to form an overlap joint or a butt joint, the plasma protection fixture 104, 300, 400 may be used to form other types of joints between workpieces, including, but not limited to lap joints, corner joints, etc. Further, the plasma protection fixture 400 may also be used to form a butt joint.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A laser welding system for joining a first workpiece to a second workpiece, comprising:
a laser welder configured to emit a laser beam at a power to form a weld to join the first workpiece and the second workpiece at a weld location; and
a plasma protection fixture coupled to a surface of at least the first workpiece, the plasma protection fixture defining an opening configured to receive the laser beam, the opening having a perimeter that surrounds and is spaced apart from the weld, and the plasma protection fixture has a height above the surface of at least the first workpiece about the perimeter of the opening that is defined based on the power of the laser beam.

2. The laser welding system of claim 1, wherein the height is 3 millimeters to 5 millimeters, and the power of the laser beam is greater than 3 kilowatts.

3. The laser welding system of claim 1, wherein the height is 5 millimeters to 10 millimeters, and the power of the laser beam is less than 3 kilowatts.

4. The laser welding system of claim 1, further comprising a secondary gas system configured to direct a flow of a gas over the surface of at least the first workpiece and the height of the plasma protection fixture is configured to inhibit the flow of the gas from disturbing weld plasma at the weld location.

5. The laser welding system of claim 1, wherein the plasma protection fixture defines a plurality of the opening, which are spaced apart on the plasma protection fixture from a first fixture side to a second fixture side.

6. The laser welding system of claim 4, wherein the weld location is a first surface of the first workpiece, the first workpiece is joined to the second workpiece with an overlap joint, the opening is rectangular, the weld is a linear stitch weld formed along a weld path, the linear stitch weld is centered in the opening, and the secondary gas system is configured to direct the flow of the gas in a direction parallel to the weld path such that the flow of the gas follows the weld path.

7. The laser welding system of claim 1, wherein the weld location is a first surface of the first workpiece, the first workpiece is joined to the second workpiece with an overlap joint, the opening is rectangular, the weld is at least one spot weld, and the at least one spot weld is positioned within the opening.

8. The laser welding system of claim 1, wherein the plasma protection fixture includes a coupling system configured to apply a pressure to at least the first workpiece.

9. The laser welding system of claim 8, wherein the plasma protection fixture defines a fixture bore, and the coupling system comprises a mechanical fastener configured to be received through the fixture bore to apply the pressure to at least the first workpiece.

10. The laser welding system of claim 9, wherein the mechanical fastener is a turn screw or a spring pin.

11. The laser welding system of claim 1, wherein the laser welder is operable in a keyhole welding mode and a conduction welding mode, and the height above the surface of at least the first workpiece about the perimeter of the opening is defined based on the keyhole welding mode or the conduction welding mode.

12. The laser welding system of claim 1, wherein the weld location is the surface of the first workpiece proximate a first end of the first workpiece and a second surface of the second workpiece proximate a second end of the second workpiece, and the first workpiece is joined to the second workpiece with a butt joint.

13. The laser welding system of claim 1, wherein the weld location is a first surface of the first workpiece, and the first workpiece is joined to the second workpiece with an overlap joint.

14. The laser welding system of claim 1, wherein the plasma protection fixture includes at least one handle.

15. A laser welding system for joining a first workpiece to a second workpiece, comprising:
a laser welder configured to emit a laser beam at a power to form a weld to join the first workpiece and the second workpiece along a weld path, the laser welder operable in a welding mode, the welding mode including a keyhole welding mode and a conduction welding mode;
a secondary gas system configured to direct a flow of a gas over a surface of at least the first workpiece in a direction parallel to the weld path such that the flow of the gas follows the weld path; and
a plasma protection fixture defining a fixture bore and a coupling system including a mechanical fastener configured to be received through the fixture bore and configured to apply a pressure to the surface of at least the first workpiece, the plasma protection fixture defining an opening configured to receive the laser beam, the coupling system defined about a perimeter of the opening, the perimeter of the opening surrounds and is spaced apart from the weld path that is defined within the opening, the plasma protection fixture has a height above the surface of at least the first workpiece about the perimeter of the opening that is defined based on the welding mode and the height of the plasma protection fixture is configured to inhibit the flow of the gas from disturbing weld plasma along the weld path.

16. The laser welding system of claim 15, wherein the height is 3 millimeters to 5 millimeters, and the welding mode is the keyhole welding mode.

17. The laser welding system of claim 15, wherein the height is 5 millimeters to 10 millimeters and the welding mode is the conduction welding mode.

18. The laser welding system of claim 15, wherein the plasma protection fixture defines a plurality of the opening, which are spaced apart on the plasma protection fixture from a first fixture side to a second fixture side.

19. The laser welding system of claim 15, wherein the opening is rectangular, and the weld path is linear to form a stitch weld.

20. The laser welding system of claim 15, wherein the mechanical fastener is a turn screw, a spring pin, or a spring biased pin.
